(19) United States
(12) Patent Application Publication
(10) Pub. No.: US 2015/0012569 A1
(43) Pub. Date: Jan. 8, 2015

(54) METHOD, APPARATUS AND COMPUTER PROGRAM PRODUCT FOR CONVERSION OF A MEDIA FILE

(71) Applicant: Nokia Corporation, Espoo (FI)

(72) Inventors: Arto Juhani Lehtiniemi, Lempaala (FI); Jussi Artturi Leppanen, Tampere (FI); Antti Johannes Eronen, Tampere (FI)

(21) Appl. No.: 13/936,611

(22) Filed: Jul. 8, 2013

(51) Int. Cl. G06F 17/30

(52) U.S. Cl. CPC G06F 17/30076
USPC 707/821

(57) ABSTRACT

Provided herein is a method, apparatus and computer program product for the generation of a second media file by the application of a conversion parameter to a first media file. In particular, the method may include providing for a first media file, the first media file including at least one first characteristic, providing for a conversion parameter, applying the conversion parameter to the first media file, and generating, by a processor, a second media file having at least one second characteristic. The at least one second characteristic may have a level of equivalence with the at least one first characteristic where the level of equivalence is determined by the conversion parameter.

### TECHNOLOGICAL FIELD

Example embodiments of the present invention relate generally to the conversion of a media file, and more particularly, to the conversion of a media file using a conversion parameter in order to generate a second media file which has a level of equivalence to the original media file.

### BACKGROUND

The modern communications era has brought about a tremendous expansion of wireline and wireless networks. Computer networks, television networks, and telephone networks are experiencing an unprecedented technological expansion, fueled by consumer demand. Wireless and mobile networking technologies have addressed consumer demands while providing more flexibility and immediacy of information transfer.

Devices, such as mobile devices are capable of providing functionality including the presentation of media files to a user. With the vast amounts of media files available to users, stored either locally or available over a network, users have a tremendous amount of media files available to them from around the world. Media players, which may be embodied on numerous devices, may allow a user to view or listen to media files and provide them access to information related to those media files. This information may provide useful guidance to a user who is seeking other media files for their own, or for another user's enjoyment.

### SUMMARY

In general, an example embodiment of the present invention provides a method, apparatus, and computer program product for generating a second media file from a first media file by the application of a conversion parameter to the first media file. In particular, the method of example embodiments may include providing for a first media file, the first media file including at least one first characteristic, providing for a conversion parameter, applying the conversion parameter to the first media file, and generating, by a processor, a second media file having at least one second characteristic. The at least one second characteristic may have a level of equivalence with the at least one first characteristic where the level of equivalence is determined by the conversion parameter.

The at least one first characteristic may include an artist, a genre, a language, or a gender, and the application of the conversion parameter to the first media file may include converting at least one of the artist, the genre, the language, or the gender according to the conversion parameter. In some embodiments, at least two of the artist, the genre, the language, or the gender remain the same between the first media file and the second media file. Generating a second media file may include at least one of generating an identification of a known, previously existing media file or generating a new media file. The first media file may be of a first culture, where the conversion parameter includes a culture conversion parameter, and the second media file may be of a second culture corresponding to the culture conversion parameter. Alternatively, the conversion parameter may include a genre conversion parameter, where the second media file includes a version of the first media file corresponding to the genre conversion parameter. As yet another alternative, the conversion parameter may include a musical instrument conversion parameter defining a musical instrument, where the second media file is a subset of the first media file and the second media file includes portions of the first media file including the musical instrument. Providing a conversion parameter may include providing for display of a representation of the conversion parameter. Applying the conversion parameter to the first media file may include receiving a dragging gesture initiated at the representation of the conversion parameter and extending at least partially across a representation of the first media file.

Example embodiments of the invention may provide an apparatus including at least one processor and at least one memory including computer program code. The at least one memory and the computer program code are configured to, with the at least one processor, cause the apparatus to provide for a first media file with the first media file including at least one first characteristic, provide a conversion parameter, apply the conversion parameter to the first media file, and generate a second media file having at least one second characteristic. The at least one second characteristic may have a level of equivalence with the at least one first characteristic and the level of equivalence may be determined by the conversion parameter.

The at least one first characteristic may include an artist, a genre, a language, or a gender. As such, causing the apparatus to apply the conversion parameter to the first media file in accordance with this embodiment may include causing the apparatus to convert at least one of the artist, the genre, the language, or the gender according to the conversion parameter. In some embodiments, at least two of the artist, the genre, the language, or the gender remain the same between the first media file and the second media file. Causing the apparatus to generate a second media file may include causing the apparatus to generate an identification of a known, previously existing media file and/or causing the apparatus to generate a new media file. The first media file may be of a first culture. In an embodiment in which the conversion parameter includes a culture conversion parameter of a second culture, the second media file may be of the second culture. The conversion parameter may alternatively include a genre conversion parameter, and the second media file may include a version of the first media file corresponding to the genre conversion parameter. Still further, the conversion parameter may include a musical instrument conversion parameter defining a musical instrument, and the second media file may be a subset of the first media file including the portions of the first media file that include the musical instrument. Causing the apparatus to provide a conversion parameter may include causing the apparatus to provide for display of a representation of the conversion parameter. Causing the apparatus to apply the conversion parameter may include causing the apparatus to receive a dragging gesture initiated at the representation of the conversion parameter and extending at least partially across a representation of the first media file.

Embodiments of the present invention may provide a computer program product including at least one non-transitory, computer-readable storage medium having computer executable program code instructions stored therein. The computer executable program code instructions may include program code instructions to provide for a first media file that includes at least one characteristic, program code instructions to provide a conversion parameter, program code instructions to apply the conversion parameter to the first media file, and program code instructions to generate a second media file. The second media file may have at least one second characteristic that has a level of equivalence with the at least one first characteristic, and the level of equivalence may be determined by the conversion parameter.

The at least one first characteristic may include an artist, a genre, a language, or a gender. As such, the program code instructions to apply the conversion parameter to the first media file may include program code instructions to convert at least one of the artist, the genre, the language, or the gender according to the conversion parameter. According to some example embodiments, at least two of the genre, the artist, the language, or the gender remain the same between the first media file and the second media file. The program code instructions to generate a second media file may include at least one of program code instructions to generate an identification of a known, previously existing media file or program code instructions to generate a new media file. The first media file may be of a first culture. In an instance in which the conversion parameter includes a culture conversion parameter of a second culture, the second media file may be of the second culture. The conversion parameter may alternatively include a genre conversion parameter, and the second media file may include a version of the first media file corresponding to the genre conversion parameter. The program code instructions for providing a conversion parameter may include program code instructions for providing for display of a representation of the conversion parameter. The program code instructions for applying the conversion parameter to the first media file may include program code instructions for receiving a dragging gesture initiated at the representation of the conversion parameter and extending at least partially across a representation of the first media file.

Example embodiments of the present invention may include an apparatus comprising means for providing for a first media file that includes at least one first characteristic, means for providing for a conversion parameter, means for applying the conversion parameter to the first media file, and means for generating a second media file having at least one second characteristic. The at least one second characteristic may have a level of equivalence with the at least one first characteristic where the level of equivalence is determined by the conversion parameter. The at least one first characteristic may include an artist, a genre, a language, or a gender. As such, the means for applying the conversion parameter to the first media file may include means for converting at least one of the artist, the genre, the language, or the gender according to the conversion parameter. In some embodiments, at least two of the artist, the genre, the language, or the gender remain the same between the first media file and the second media file. The means for generating a second media file may include at least one of means for generating an identification of a known, previously existing media file or means for generating a new media file. The first media file may be of a first culture. In this instance, the conversion parameter includes a culture conversion parameter, and the second media file may be of a second culture corresponding to the culture conversion parameter. The conversion parameter may alternatively include a genre conversion parameter. In this embodiment, the second media file includes a version of the first media file corresponding to the genre conversion parameter. Still further, the conversion parameter may include a musical instrument conversion parameter defining a musical instrument such that the second media file is a subset of the first media file with the second media file including portions of the first media file that include the musical instrument. The means for providing a conversion parameter may include means for providing for display of a representation of the conversion parameter. The means for applying the conversion parameter to the first media file may include means for receiving a dragging gesture initiated at the representation of the conversion parameter and extending at least partially across a representation of the first media file.

### DRAWINGS

Having thus described example embodiments of the invention in general terms, reference will now be made to the accompanying drawings, which are not necessarily drawn to scale, and wherein:

FIG. 1 is a schematic block diagram of an apparatus which may generate a second media file by applying a conversion parameter to a first media file according to an example embodiment of the present invention;

FIG. 2 is an illustration of a device providing for display of a first media file;

FIG. 3 is an illustration of a table defining an up-tempo conversion parameter and a German culture conversion parameter;

FIGS. 4A-4C illustrate selecting a conversion parameter on a device;

FIGS. 5A-5C illustrate the application of a conversion parameter to a first media file to generate a second media file according to an example embodiment of the present invention; and

FIG. 6 is a flowchart of a method for generating a second media file by applying a conversion parameter to a first media file according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Some embodiments of the present invention may relate to provision of a mechanism by which a media file is converted from a first media file to a second media file. Example embodiments of the present invention may be configured to convert media files of any type or format; however, for purposes of illustration, example embodiments described herein are primarily directed to music media files. It is appreciated that embodiments may be similarly applied to images, videos, podcasts, illustrations, etc. The conversion of a media file may be from a first media file to a second media file using a conversion parameter to dictate or instruct the conversion. Conversion may be performed to modify an existing media file, to create a new media file, or to determine an existing media file which satisfies the conversion parameter. The converted, second media file may be related to the first media file through a level of equivalence of at least one feature that is established by the conversion parameter.

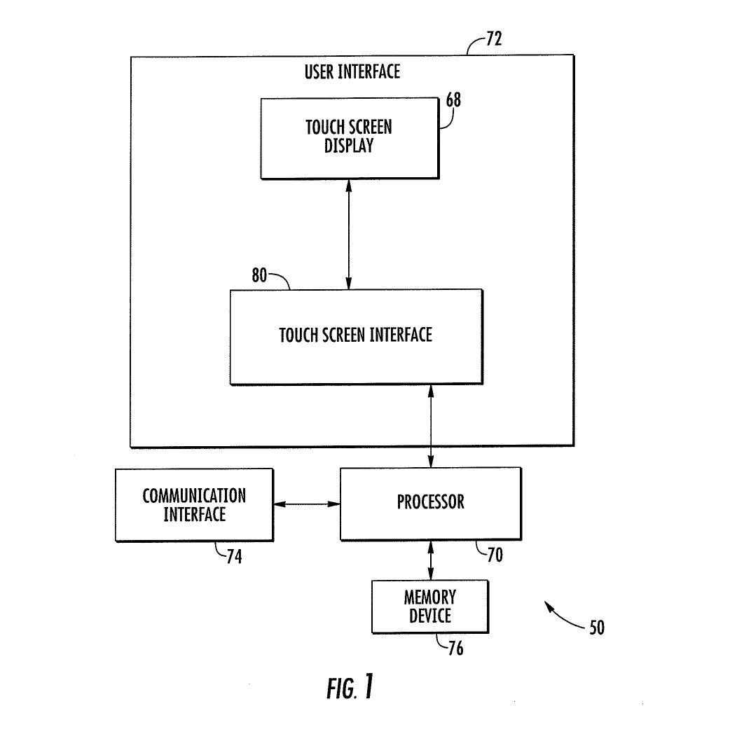

One example embodiment of the invention is depicted in FIG. 1 which illustrates a block diagram of an apparatus 50 that would benefit from embodiments of the present invention. It should be understood, however, that the mobile apparatus 50 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices, such desktop computers may similarly be configured in accordance with embodiments of the present invention.

An example embodiment of the present invention will now be described with reference to FIG. 1, in which certain elements of an apparatus 50 for providing a mechanism by which a conversion parameter may be applied to a first media file to generate a second media file is illustrated. The apparatus 50 may, in some embodiments, be a mobile terminal or a computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen(s), touch areas, device surfaces and/or sensors capable of detecting objects hovering over the surface, soft keys, a microphone, a speaker, motion sensor, temperature sensor, accelerometer, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a display, such as the illustrated touch screen display 68. In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, etc. techniques. The user interface 72 may be in communication with the touch screen display 68 to receive indications of user inputs at the touch screen display 68 and to modify a response to such indications based on corresponding user actions that may be inferred or otherwise determined responsive to the indications. In one alternative, a touch input may be provided other than by direct interaction with a display (e.g., in cases where the user interface is projected onto a wall with a projector, or where a cursor is used to direct input on the display).

In an example embodiment, the apparatus 50 may include a touch screen interface 80. The touch screen interface 80 may, in some instances, be a portion of the user interface 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an indication of an input in the form of a touch event at the touch screen display 68. As such, the touch screen interface 80 may be in communication with the touch screen display 68 to receive indications of user inputs at the touch screen display 68 and to modify a response to such indications based on corresponding user actions that may be inferred or otherwise determined responsive to the indications. Following recognition of a touch event, the touch screen interface 80 may be configured to determine a classification of the touch event and provide a corresponding function based on the touch event in some situations. Optionally, a device may be configured to recognize a hovering input where a user may use a stylus or finger to hover over a tile or interactive element and the device may be configured to recognize the hovering as an input, for example, by using user interface 72.

While the illustrated apparatus 50 of FIG. 1 includes a user interface having a display, embodiments of the present invention may be implemented on devices which lack a display and/or user interface. As noted above, the apparatus 50 of FIG. 1 is provided for illustrative purposes and is not intended to be limiting. In particular, the user interface 72 and display 68 may be implemented to establish a particular graphical user interface in order to implement embodiments of the present invention.

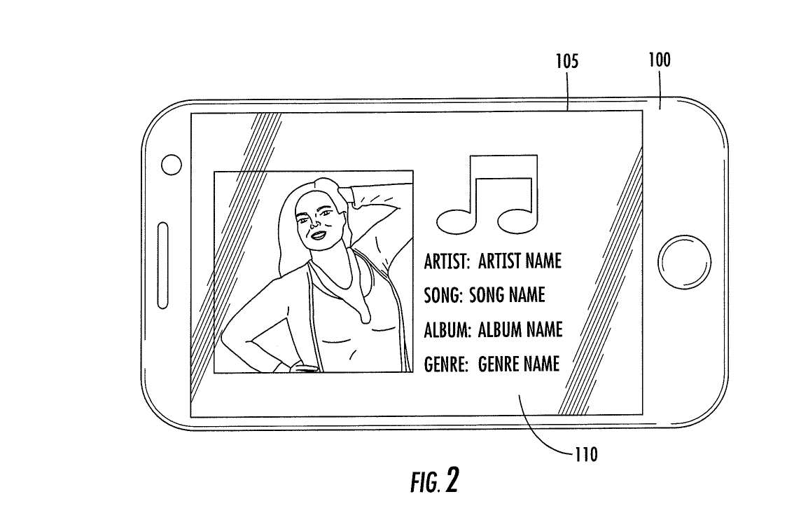

As outlined herein, example embodiments of the apparatus may be configured for the conversion of a first media file to a second media file by the application of a conversion parameter. FIG. 2 illustrates an example embodiment of a device 100 for playing a media file which includes an audio file or music file. The device 100 may include a display 105 (e.g., display 68 of FIG. 1) upon which information 110 relating to the media file may be presented, for example, by processor 70. In the illustrated embodiment, the information 110 presented may include an artist, song, album, and genre. According to some example embodiments, more or less information regarding the media file may be presented. For example, in some embodiments only a picture of the artist or album may be shown, and in still other embodiments, only text may be shown. The first media file may be stored locally on the device 100 (e.g., in memory device 76 of apparatus 50), or accessed via a network (e.g., through communications interface 74).

In some situations, a user may wish to generate a second media file from the first media file, while maintaining some level of equivalence with the first media file. As such, the user may apply a conversion parameter to the first media file in order to generate a second media file. The generation of the second media file may be performed (e.g., by processor 70) by generating a new media file that meets the criteria of the conversion parameter, or optionally, the generation of the second media file may include generating an identification of a second media file that already exists that meets the conversion parameter criteria.

Media files may each include or otherwise be associated with information relating to the media file. This information may be stored, such as in the form of metadata, with or otherwise in association with the media file. For a music media file, the information contained in the metadata may include an artist, an album, a language (e.g., the language of the song), a culture (e.g., a culture related to the music type or artist type), a genre, length of the music file, rhythm, subject matter, album label, producer, etc. While some of this information may be presented on a display of a device, such as information 110 of device 100 of FIG. 2, additional information relating to the media file may exist in the metadata. Further, while metadata may include information about the media file, additional information about the media file may be available such as in a locally stored database (e.g. in memory device 76) or in a database accessible via a network (e.g., via communications interface 74). The additional information may include information that is not available at the time the media file was generated, or may include information that goes beyond the information available in the metadata. For example, information about a musical artist's history with other bands or other musical ventures may be included in information that is stored elsewhere other than in the metadata of the media file. Additionally, information about the artist's popularity or target demographics may also be available as described further below.

In an example embodiment of a video media file, the information about the media file may include actors or people featured in the media file, directors, writers, or other people associated with the media file, subject matter of the video, genre, times at which certain actors or individuals are in the video (e.g., when a certain actor enters a scene and when they leave), etc. Some or all of this information may be stored with the media file in the metadata or otherwise available to an apparatus 50, whether it is stored locally in memory device 76 or accessible via a network through communications interface 74.

In an example embodiment of an image media file, the information about the media file may include a date of the image creation, people included in the image, location of the image, points-of-interest in the image, etc. All of this information may be available for use in applying a conversion parameter according to example embodiments of the present invention.

According to an example embodiment, a user may have a particular preference for music and may enjoy music from a particular artist or band. However, that artist or band may have a wide range of music that they have recorded. While listening to, or simply identifying a first media file that is a song of the particular artist or band, the user may decide that they want to listen to that same artist or band, but they would prefer to listen to a more up-tempo song. In such an embodiment, the user may select an up-tempo conversion parameter, such as through user interface 72. The up-tempo conversion parameter may be applied to the identified song, such as by processor 70, and the apparatus 50 may generate an up-tempo version of the song, or an up-tempo song from the same artist or band. Generating an up-tempo version of the song or an up-tempo song of the same artist may be performed by the processor 70 and may include generating a media file that previously did not exist (e.g., generating an up-tempo version of the same song by application of an algorithm) or generating an identification of a previously existing media file that meets the criteria of the conversion parameter. Generating the identification of a previously existing media file may identify a media file that is stored locally, such as in memory device 76, or the previously existing media file may be identified locally by processor 70 and accessed remotely via communications interface 74. In this manner, embodiments of the present invention may generate a second media file which is up-tempo relative to the first media file, according to the conversion parameter selected. The second media file may have a level of equivalence to the first media file that is established by the conversion parameter. According to the described embodiment, the level of equivalence may include an artist or band that is the same, while finding a media file that has information indicating that the tempo is faster than the first media file.

Conversion parameters according to example embodiments may be generated or created by a user or may be selected from a plurality of available conversion parameters. Conversion parameters may be stored, for example in memory device 76, may be accessible via through a network, such as via communications interface 74, and/or may be input or provided by a user. Each conversion parameter may be configured to convert at least one characteristic or item of information of a first media file, while retaining at least one characteristic or item of information of the first media file. For example, a conversion parameter such as the “up-tempo” conversion parameter described above may be configured to convert the tempo characteristic of a media file such that the information related to the tempo of the first media file is changed from the first media file to the second media file. The up-tempo conversion parameter is an example of a relative parameter in that it defines a tempo characteristic of the second media file, not in terms of an absolute value, but in relative terms with respect to the first media file. Alternatively, the conversion parameter may be an absolute parameter which specifies a characteristic of the second media file, regardless of the manner in which that same characteristic was presented, if at all, by the first media file.

The up-tempo conversion parameter may also be configured to maintain equivalence between other characteristics or items of information of the first media file. For example, the up-tempo conversion parameter may be configured to keep the artist or band the same between the first media file and the second media file. The conversion parameter may include some pieces of information (characteristics) that are to be converted according to the conversion parameter and some pieces of information that are to be maintained in equivalence between the first media file and the second media file. Other available pieces of information that are not specified in the conversion parameter may be deemed unimportant to the conversion such that the level of equivalence between the unspecified information in the first media file and the second media file is unimportant and, as such, may either differ or remain the same between the first and second media files.

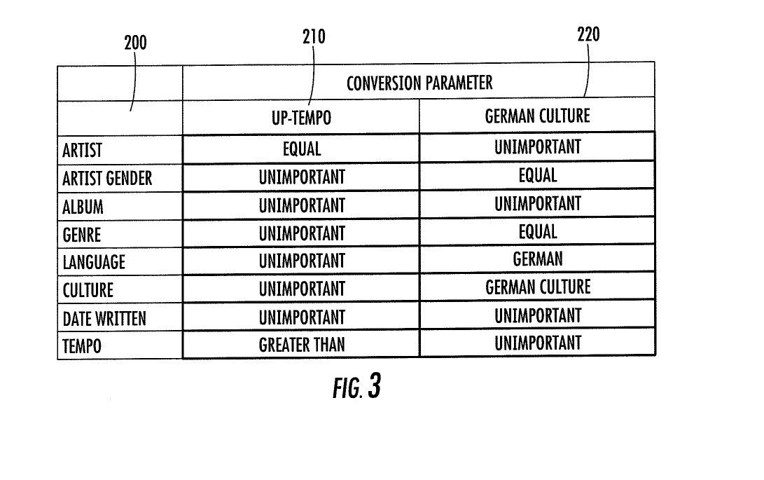

FIG. 3 illustrates an example embodiment of conversion parameters for “Up-Tempo” and “German Culture.” In the illustrated embodiment, media file information 200 is shown to include artist, artist gender, album, genre, language, culture, date written, and tempo. These are merely examples of information that may be available for music media files, such as through metadata or otherwise available information. Other media files may include more or less media file information, and/or different types of media file information. For the Up-Tempo conversion parameter 210, the conversion parameter may require that the artist of the first media file and the second media file that is converted from the first media file have the same, or equal artist. The artist gender may be unimportant as it is assumed that if the artist is the same, the artist gender will be the same. The album, genre, language, culture, and date written may also be considered unimportant. Each of these items of information or characteristics of the music media file may generally remain equivalent between a first media file and second media file where the artist is the same; however, it is not required by the “Up-Tempo” conversion parameter. As shown, the “tempo” characteristic may be required to be greater than the first media file in the second media file by this conversion parameter. As such, application of the “Up-Tempo” conversion parameter by processor 70 to a first media file according to the illustrated embodiment may generate a second media file from the first media file, where the second media file has the same artist, but a faster/greater tempo than the first media file.

FIG. 3 also shows a “German Culture” conversion parameter. Application of the German Culture conversion parameter to a first media file (e.g., by processor 70) may generate a second media file where the artist gender and genre remain equivalent, while the language of the second media file is required to be German and the culture is required to be of a German culture. The artist, album, date written, and tempo may be irrelevant. In practice, application of the German Culture conversion parameter may result in a second media file which includes substantially a German culture equivalent to an artist of another culture.

Additional information may be considered when applying a conversion parameter to a first media file, such as popularity of a media file (e.g., is the media file or artist of the media file popular on a video-sharing website), a demographic of the artist of the media file (e.g., is the artist popular with listeners ages 35-45), etc. This additional information is representative of information which may not be defined in the metadata of a media file, but may be obtained from other sources available via a network such as the Internet, accessible via communications interface 74. As such, the conversion parameters of example embodiments may further consider information or characteristics of a media file which are not inherent to the media file itself.

In an example embodiment in which additional information is available for use with a conversion parameter, the additional information may be used to determine the level of equivalence between a first media file and a second media file. In an embodiment in which a conversion parameter is applied to a first media file, where the conversion parameter includes a level of popularity of the first media file, a second media file may be generated that has a level of popularity within a predetermined tolerance of the level of popularity of the first media file. A conversion parameter applied to a first media file that has a 95% approval or “like” rating on a popular social media website may generate a second media file that has a similar approval or “like” rating, such as between 92% and 97%, which would equate to a predetermined tolerance of +/−3% approval rating. Another example embodiment of the use of a conversion parameter that considers additional information may include where a conversion parameter is applied to a first media file which has a high popularity among a specific demographic may generate a second media file which has a high popularity (e.g., within a predefined tolerance of the popularity of the first media file) with the same demographic (e.g., girls, between the ages of 12 and 22).

Further, while the example embodiment of FIG. 3 illustrates that characteristics of media files are either equal, unimportant, or specified to be of a certain type or value, embodiments may also include where a characteristic of a second media file is required to be “similar” to a first media file. For example, if an artist of a first media file is required by a conversion parameter to be “similar” to the artist of a second media file, the similarities may be established by one or more characteristics related to the artists including, for example, artist age, gender, demographics, ethnicity, etc. Optionally, the similarity may be given a value, such as 90% similar where 90% of the characteristics of an artist are required to be the same between a first media file and a second media file in order to establish similarity. Similarity may also include an artist's prior or later involvement with other musical entities or bands such that media files by the artist or the other musical entities or bands with which the artist was involved are considered similar. For example, the solo artist Sting may be similar to the band The Police because Sting was a member of The Police. The solo artist Eric Clapton may be similar to the bands Derek and the Dominos and Cream since Eric Clapton was a member of each of those bands. In this manner, a degree of similarity may be required by a conversion parameter to better convey how a user may want to convert a first media file to a second media file in an instance in which equivalence between the parameters is not required.

An example embodiment of an implementation of the present invention may include where a user listens to the Finnish artist Kaija Koo, such as on an apparatus 50. The user may recall that the following day they are to have dinner with their German friends. The user may not be familiar with German music, but knowing that Kaija Koo is popular in Finland for members of their friends' demographics, the user may apply a German culture conversion parameter to the Kaija Koo song to which they are listening. Application of the German culture conversion parameter using processor 70 may result in a song from Andrea Berg being generated since Andrea Berg may be considered to be to Germany what the artist Kaija Koo is to Finland. Embodiments of the present invention may provide a graphical user interface which can be used to apply the conversion parameter in a user friendly manner that is easily understood by a user.

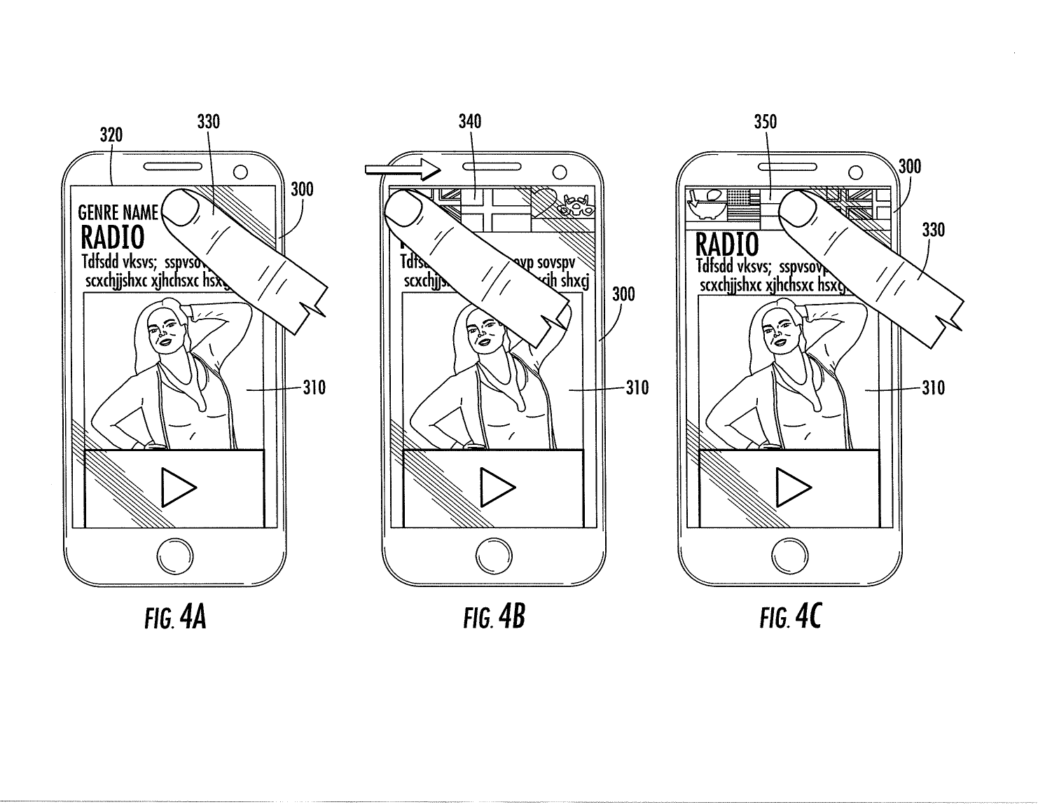

FIG. 4A depicts an example embodiment of a display 300 of an apparatus (e.g., apparatus 50) that is playing a music media file of an artist. In the example embodiment, the artist may be Kaija Koo 310. The conversion parameter may be selected in various manners, but, in the illustrated embodiment, the user 330 may touch the display 300 (e.g., touch screen 68 of apparatus 50) proximate a location of the touch screen 320 that is preconfigured for the selection of a conversion parameter. A plurality of conversion parameters 340 may be presented on the display 300. The user 330 may scroll through the plurality of conversion parameters 340 as shown in FIG. 4B, for example by dragging a finger 330 across the display 300. Upon finding the desired conversion parameter, in this case a German culture conversion parameter 350, which may be represented by a German flag, the user 330 may select the German culture conversion parameter 350, such as by tapping on the German flag icon 350, as shown in FIG. 4C. Conversion parameters may be presented to a user on a display using representations of the conversion parameter. The above referenced example includes a German flag icon as a representation of the German culture conversion parameter. Other culture conversion parameters may be represented by flags, symbols (e.g., country abbreviations), images, words, or any combination thereof to convey the type of conversion parameter to a user intuitively.

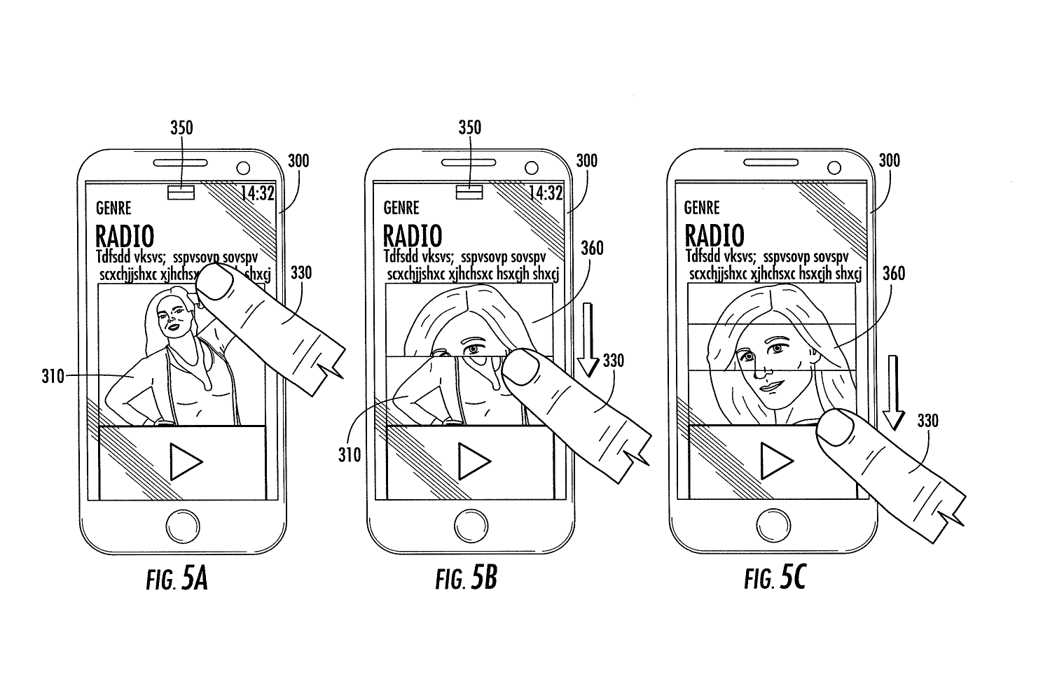

Upon selection of the German culture conversion parameter 350, the user 330 may apply the conversion parameter to the media file which is currently playing (e.g., the first media file). FIGS. 5A-5C illustrate the application of the conversion parameter 350 where the user 330 begins to drag their finger down the display 300 in FIG. 5A. FIG. 5B depicts the German culture conversion parameter being applied where the user's finger 330 is midway down the display. As the user's finger 330 drags across the image of Kaija Koo 310, which may be an image from the album or song that is playing or otherwise identified, the image of Kaija Koo 310 is replaced by an image of Andrea Berg 360, who may be considered the German culture equivalent to Kaija Koo in Finland. FIG. 5C illustrates the German culture conversion parameter applied as the user 330 completes the action of dragging their finger down the display 300. As shown in FIG. 5C, the image of Kaija Koo 350 is replaced by an image of Andrea Berg 360. If the Kaija Koo media file is playing during the application of the German culture conversion parameter, as the German culture conversion parameter is applied, the Kaija Koo song media file, which is the first media file, may be faded into the Andrea Berg song media file, which is the second media file. In this manner, a smooth transition may be provided between the first song media file and the second song media file which is generated by the processor 70.

Application of the German culture conversion parameter in the graphic method described above may be enhanced by the image of Andrea Berg being shown through a semi-transparent illustration of the German flag. The semi-transparent German flag may be shown as the user's finger 330 is dragged down across the display 300 to convey that the German culture conversion parameter is being applied. Upon completion of the application of the German culture conversion parameter, the semi-transparent German flag may be removed and the image of Andrea Berg 360 may be shown without obstruction. While the above described embodiment uses images of the artists, example embodiments may use images of album cover artwork or any images that may be associated with a media file in order to present the graphical user interface described. Further, the above described embodiment is merely one implementation of this embodiment of the invention. Example embodiments may use other graphical user interface techniques and in some embodiments may not use graphical user interfaces, such as when a user is applying a conversion parameter via hands-free voice commands, which may be useful while a user is otherwise occupied, such as by driving a vehicle.

The above described culture conversion parameter may facilitate conversion of a first media file to a second media file of the culture specified in the culture conversion parameter by translating various aspects of a media file. A culture conversion parameter may not necessarily equate artists between cultures, but may also equate musical styles and types between cultures. For example, a first media file which is of an American culture may include heavy use of a guitar, a popular string instrument in America. If an Indian culture conversion parameter is applied to the first media file, the heavy use of guitar may be translated to heavy use of a sitar, which is a popular sting instrument in India which may be considered the Indian equivalent of an American guitar. Another example embodiment of a characteristic of a media file which may require translation between cultures may include where a first media file is of the Finnish music genre of “humppa.” Translating this music genre from Finnish to German, by application of a German culture conversion parameter, may translate the Finnish “humppa” genre to the German “schlager” genre.

While the above described embodiments convert a first media file to a second media file based on a culture conversion parameter, other conversion parameters may be implemented such as a musical instrument conversion parameter. In such an example embodiment, a user may select a guitar conversion parameter to apply to a first media file that is a music file. In response, a second media file may be generated from the first media file which includes only the portions of the first media file that include a guitar. This type of conversion parameter may be configured to generate a media file from the first media file rather than generating an identification of a second media file according to the conversion parameter as in the culture conversion parameter. Another example embodiment of this type of conversion parameter may include a “guitar solo” conversion parameter where, when applied to a first media file, a second media file is generated including only the guitar solos from the first media file. Similar conversion parameters may be implemented including musical styles, such as a “lounge” conversion parameter which converts a first media file to a second media file including only portions of the first media file that are slower in tempo and of lower intensity. Another example embodiment of a conversion parameter may include a no-vocals conversion parameter where a second media file may be generated from a first media file that includes only portions of the first media file that lack vocals. Such a media file may be useful to someone who does not want to be disturbed by the vocals of a music media file while performing other tasks, such as reading.

Conversion parameters which are configured to generate a second media file from a first media file by eliminating portions of the first media file may be implemented by the application of algorithms via processor 70, established by the conversion parameter, to the first media file. For example, musical content of a music media file may be analyzed by the processor 70 with audio signal processing methods to detect certain features of the media file such as the presence of particular instruments, vocals, tempos, intensity, etc. When such a conversion parameter is applied to a media file, the portions of the first media file that remain in the second media file following the elimination of those portions of the first media file that do not satisfy the conversion parameter, such as by include the features identified by the conversion parameter, may be seamlessly joined together by fading or by software configured to interweave the remaining portions to provide a second media file which is not “choppy” or difficult to listen to. The second media file that is generated may be stored either temporarily during playback or more permanently (e.g., until deleted by a user), for example in memory device 76.

The above described embodiments have been described with respect to converting a first media file to a second media file by applying a conversion parameter; however, conversion parameters can also be applied to multiple media files, such as a playlist of media files. In an example embodiment, a user may have a playlist, stored in memory device 76, of music media files including various artists and several genres to which they like to listen. Application of a conversion parameter by processor 70 to the first plurality of media files may generate a second plurality of media files according to the conversion parameter. The second plurality of media files of this embodiment have a level of equivalence to the first plurality of media files as dictated by the conversion parameter. The second plurality of media files may contain, for example, a plurality of German culture media files, where each German culture media file has some level of equivalence to at least one media file of the first plurality of media files.

As noted above, the second media file, or second plurality of media files may be generated, such as when a guitar solo conversion parameter is applied to a first media file to arrive at a second media file that essentially is a subset of the first media file. In this embodiment, the subset includes only the guitar solo portions of the first media file. However, in example embodiments where the conversion parameter generates a second media file or a plurality of second media files that is, for example of another culture, the generation of the second media file may comprise identifying the second media file(s). The second media file may be stored on a user device, such as in memory device 76 of apparatus 50, or the second media file may be retrieved, such as through communications interface 74, from a database that is remote from the apparatus 50 and is available, for example through a network, such as the Internet.

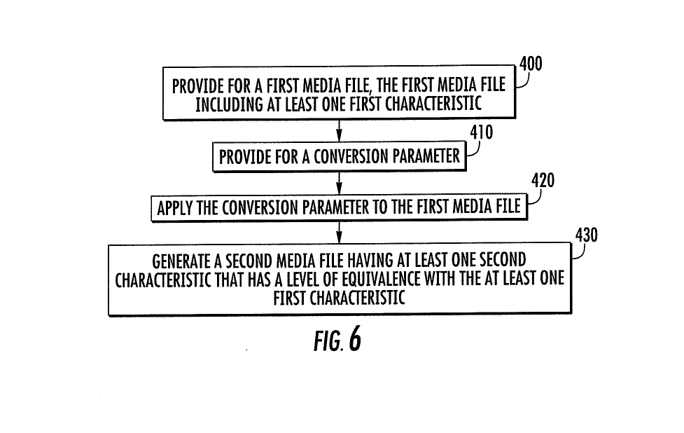

FIG. 6 is a flowchart of a method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user device and executed by a processor in the user device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 6, may include providing for a first media file at 400. The first media file includes at least one first characteristic. A conversion parameter may be provided at 410. The conversion parameter may be applied to the first media file at 420. A second media file having at least one second characteristic may be generated at 430. The at least one second characteristic has a level of equivalence with the at least one first characteristic that is defined by the conversion parameter.

In an example embodiment, an apparatus for performing the method of FIG. 6 may comprise a processor (e.g., the processor 70) configured to perform some or each of the operations (400-430) described above. The processor 70 may, for example, be configured to perform the operations (400-430) by performing hardware implemented logical functions, executing stored instructions, or executing algorithms for performing each of the operations. Alternatively, the apparatus may comprise means, such as the processor, at least one processor and at least one memory including a computer program code, a computer program product, or the like for performing each of the operations described above.

An example of an apparatus according to an example embodiment may include at least one processor and at least one memory including computer program code. The at least one memory and the computer program code may be configured to, with the at least one processor, cause the apparatus to perform the operations 400-430.

An example of a computer program product according to an example embodiment may include at least one computer-readable storage medium having computer-executable program code portions stored therein. The computer-executable program code portions may include program code instructions for performing operations 400-430.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for a first media file, the first media file including at least one first characteristic;
providing a conversion parameter;
applying the conversion parameter to the first media file; and
generating, by a processor, a second media file having at least one second characteristic, wherein the at least one second characteristic has a level of equivalence with the at least one first characteristic and wherein the level of equivalence is determined by the conversion parameter.

2. The method of claim 1, wherein the at least one first characteristic comprises an artist, a genre, a language, and a gender, wherein application of the conversion parameter to the first media file comprises converting at least one of the artist, the genre, the language, or the gender according to the conversion parameter.

3. The method of claim 2, wherein at least two of the artist, the genre, the language, or the gender remain the same between the first media file and the second media file.

4. The method of claim 1, wherein generating a second media file comprises at least one of generating an identification of a known, previously existing media file or generating a new media file.

5. The method of claim 1, wherein the first media file is of a first culture, wherein the conversion parameter comprises a culture conversion parameter of a second culture, and wherein the second media file is of the second culture.

6. The method of claim 1, wherein the conversion parameter comprises a genre conversion parameter, and wherein the second media file comprises a version of the first media file corresponding to the genre conversion parameter.

7. The method of claim 1, wherein the conversion parameter comprises a musical instrument conversion parameter defining a musical instrument, and wherein the second media file is a subset of the first media file, the second media file comprising portions of the first media file including the musical instrument.

8. The method of claim 1, wherein providing a conversion parameter comprises providing for display of a representation of the conversion parameter, and wherein applying the conversion parameter to the first media file comprises receiving a dragging gesture initiated at the representation of the conversion parameter and extending at least partially across a representation of the first media file.

9. An apparatus comprising at least one processor and at least one memory including computer program code, the at least one memory and the computer program code configured to, with the at least one processor, cause the apparatus to:
provide for a first media file, the first media file including at least one first characteristic;
provide a conversion parameter;
apply the conversion parameter to the first media file; and
generate a second media file having at least one second characteristic, wherein the at least one second characteristic has a level of equivalence with the at least one first characteristic and wherein the level of equivalence is determined by the conversion parameter.

10. The apparatus of claim 9, wherein the at least one first characteristic comprises an artist, a genre, a language, and a gender, wherein causing the apparatus to apply the conversion parameter to the first media file comprises causing the apparatus to convert at least one of the artist, the genre, the language, or the gender according to the conversion parameter.

11. The apparatus of claim 10, wherein at least two of the artist, the genre, the language, or the gender remain the same between the first media file and the second media file.

12. The apparatus of claim 9, wherein causing the apparatus to generate a second media file comprises at least one of causing the apparatus to generate an identification of a known, previously existing media file or causing the apparatus to generate a new media file.

13. The apparatus of claim 9, wherein the first media file is of a first culture, wherein the conversion parameter comprises a culture conversion parameter of a second culture, and wherein the second media file is of the second culture.

14. The apparatus of claim 9, wherein the conversion parameter comprises a genre conversion parameter, and wherein the second media file comprises a version of the first media file corresponding to the genre conversion parameter.

15. The apparatus of claim 9, wherein the conversion parameter comprises a musical instrument conversion parameter defining a musical instrument, and wherein the second media file is a subset of the first media file, the second media file comprising portions of the first media file including the musical instrument.

16. The apparatus of claim 9, wherein causing the apparatus to provide a conversion parameter comprises causing the apparatus to provide for display of a representation of the conversion parameter, and wherein causing the apparatus to apply the conversion parameter to the first media file comprises causing the apparatus to receive a dragging gesture initiated at the representation of the conversion parameter and extending at least partially across a representation of the first media file.

17. A computer program product comprising at least one non-transitory computer-readable storage medium having computer executable program code instructions stored therein, the computer executable program code instructions comprising:
program code instructions to provide for a first media file, the first media file including at least one first characteristic;
program code instructions to provide a conversion parameter;
program code instructions to apply the conversion parameter to the first media file; and
program code instructions to generate a second media file having at least one second characteristic, wherein the at least one second characteristic has a level of equivalence with the at least one first characteristic and wherein the level of equivalence is determined by the conversion parameter.

18. The computer program product of claim 17, wherein the at least one first characteristic comprises an artist, a genre, a language, and a gender, wherein the program code instructions to apply the conversion parameter to the first media file comprises program code instructions to convert at least one of the artist, the genre, the language, or the gender according to the conversion parameter.

19. The computer program product of claim 18, wherein at least two of the artist, the genre, the language, or the gender remain the same between the first media file and the second media file.

20. The computer program product of claim 17, wherein the program code instructions to generate a second media file comprises at least one of program code instructions to generate an identification of a known, previously existing media file or program code instructions to generate a new media file.

21. The computer program product of claim 17, wherein the first media file is of a first culture, wherein the conversion parameter comprises a culture conversion parameter of a second culture, and wherein the second media file is of the second culture.

22. The computer program product of claim 17, wherein the conversion parameter comprises a genre conversion parameter, and wherein the second media file comprises a version of the first media file corresponding to the genre conversion parameter.

23. The computer program product of claim 17, wherein the program code instructions for providing a conversion parameter comprises program code instructions for providing for display of a representation of the conversion parameter, and wherein the program code instructions for applying the conversion parameter to the first media file comprises program code instructions for receiving a dragging gesture initiated at the representation of the conversion parameter and extending at least partially across a representation of the first media file.
